(19) United States
(12) Patent Application Publication
(10) Pub. No.: US 2017/0043298 A1
(43) Pub. Date: Feb. 16, 2017

(54) METHOD FOR OPERATING CLARIFYING-FILM MODULE

(71) Applicant: TORAY INDUSTRIES, INC., TOKYO (JP)

(72) Inventors: Masayuki Shintani, Otsu-shi, Shiga (JP); Kenichi Okubo, Otsu-shi, Shiga (JP)

(73) Assignee: TORAY INDUSTRIES, INC., TOKYO (JP)

(21) Appl. No.: 15/306,613

(22) PCT Filed: Apr. 23, 2015
(86) PCT No.: PCT/JP2015/062450

§ 371 Date: Oct. 25, 2016

(30) Foreign Application Priority Data
Apr. 25, 2014 (JP) 2014-091197

(51) Int. Cl. B01D 65/02; C02F 1/44

(52) U.S. Cl. CPC B01D 65/02; C02F 1/44; B01D 2321/18; C02F 2303/16; B01D 2321/04; B01D 2321/16

(57) ABSTRACT

In a method for operating a clarification membrane module the invention, either following steps is conducted after the position of the closed ends in the clarification membrane module is made above the position of the open ends therein: (a) closed-end high-position cleaning step A in which the outer side of the clarification membranes within the clarification membrane module is filled with liquid and air scrubbing is then performed by supplying a gas; (b) closed-end high-position cleaning step B in which air scrubbing is conducted by supplying a gas, while supplying liquid to the outer side of the clarification membranes within the clarification membrane module.

### CROSS REFERENCE TO RELATED APPLICATIONS

This is the U.S. National Phase application of PCT International Application No. PCT/JP2015/062450, filed Apr. 23, 2015, and claims priority to Japanese Patent Application No. 2014-091197, filed Apr. 25, 2014, the disclosures of each of these applications being incorporated herein by reference in their entireties for all purposes.

### FIELD OF THE INVENTION

The present invention relates to a method for operating a clarification membrane module in which water to be treated is treated with clarification membranes.

### BACKGROUND OF THE INVENTION

Filtration devices equipped with clarification membranes have advantages such as high clarification/germ removal performance, simplicity in operation and maintenance, energy saving, space saving, etc., and are hence in extensive use in producing potable water or industrial water by clarifying and/or removing germs from ground water or surface water. Furthermore, filtration devices equipped with clarification membranes are coming to be used more widely in various fields, for example, in the production of pretreated water to be fed to reverse osmosis membrane modules for use in seawater desalination and the production of pretreated water to be fed to reverse osmosis membrane modules for treating water obtained by treating water yielded by a biological treatment of sewage or wastewater, for the purpose of clarification, germ removal, or recycling.

For example, Patent Documents 1 and 2 disclose clarification membranes. Patent Documents 3, 4, and 5 disclose clarification membrane modules. Patent Documents 6 and 7 each disclose either a fresh water production apparatus equipped with a clarification membrane module or a method for fresh water production, and further disclose a method for cleaning the clarification membrane module.

A clarification membrane module usually has the following structure. Clarification membrane modules which are usable when practicing the method for operating a clarification membrane module of the present invention also have a similar structure.

A clarification membrane module is usually configured of a case and clarification membranes housed in the case. The clarification membranes are constituted of bundles of hollow-fiber membranes. The case has been provided with: a first fluid port leading into water-to-be-treated flow channels including surfaces of the clarification membranes which come into contact with water to be treated (raw water); and a second fluid port leading into filtrate flow channels including surfaces of the clarification membranes which come into contact with filtrate. According to need, the case has been provided with a third fluid port leading into a space involving surfaces of the clarification membranes which come into contact with water to be treated.

In this clarification membrane module, one end (upper end) of each of the clarification membranes is open and serves as an opening of the filtrate flow channel. The upper ends of the clarification membranes have been configured as clarification membrane open ends by a support which prevents fluids from flowing between the water-to-be-treated flow channels and the filtrate flow channels and which fixes the clarification membranes to the case.

Furthermore, the other ends (lower ends) of the clarification membranes have been closed with a sealing member to constitute closed ends so that filtrate does not flow out through the ends on the reverse side from the openings of the filtrate flow channels.

In a filtration step for obtaining filtrate from water to be treated, the first fluid port is used as a water-to-be-treated feed port for feeding water to be treated to the water-to-be-treated flow channels. Meanwhile, the second fluid port is used as a filtrate discharge port for discharging from the filtrate flow channels the filtrate obtained by the passing of water to be treated through the clarification membranes. In this step, in cases when the water to be treated is present in the case in excess, the third fluid port is used as a discharge port for discharging the excess water to be treated from the water-to-be-treated flow channels.

Backpressure washing (hereinafter also referred to simply as “backwashing”) is conducted in order to remove the suspended substance which has adhered to the clarification membranes. In this backwashing step, the second fluid port is used as a backwashing water feed port for supplying backwashing water, specifically either the filtrate obtained in the filtration step or clarified water prepared separately from the filtrate, to the filtrate flow channels. The backwashing water flows from the inner side of the clarification membranes (i.e., from the filtrate flow channel side) to the outer side of the clarification membranes (i.e., to the water-to-be-treated flow channel side) through the clarification membranes, becoming backwashing drain. The first fluid port or the third fluid port is used as a backwashing drain port for discharging the used backwashing water. Incidentally, the terms “filtrate” and the “clarified water” which each indicate the water to be used for the backwashing are synonyms for each other unless especially otherwise indicated.

In the case where it is necessary to clean the clarification membranes with a gas, i.e., by air scrubbing, the first fluid port is usually used as a gas feed port for supplying the gas to the water-to-be-treated flow channels, and the third fluid port is usually used as a gas discharge port for discharging the gas used for the cleaning. Hereinafter, there are cases where an explanation is given on air scrubbing using air, which is the most common gas for the scrubbing.

One example of such clarification membrane modules is shown in FIG. 1. In the clarification membrane module 14a shown in FIG. 1, the clarification membranes 1 are clarification membranes constituted of bundles of a plurality of hollow fibers. The clarification membranes 1 have been housed in a case (pressure vessel) 4. One end (upper end) of each of the clarification membranes 1 constitutes an open end 2, while the other end (lower end) thereof constitutes a closed end 3. Water to be treated is passed from the outer side of the clarification membranes 1 toward the inner side thereof to filtrate the water to be treated. The filtrate within the clarification membranes 1 is taken out through the open ends 1 This hollow-fiber clarification membrane module 14a is an external-pressure type hollow-fiber clarification membrane module.

Generally employed as methods for cleaning such a clarification membrane module 14a are: backwashing in which cleaning water such as the filtrate or clarified water is passed in the direction reverse to the filtration direction, that is, from the inner side of the clarification membranes 1 (i.e., from the filtrate flow channel side) to the outer side of the clarification membranes 1 (i.e., to the water-to-be-treated flow channel side); and air scrubbing in which a gas (generally air) is introduced as bubbles into the outer side of the clarification membranes 1 (i.e., into the water-to-be-treated channel side).

### PATENT DOCUMENT

Patent Document 1: Japanese Patent No. 4835221

Patent Document 2: Japanese Patent No. 3760838

Patent Document 3: JP-A-2006-231146

Patent Document 4: JP-A-2007-125452

Patent Document 5: U.S. Pat. No. 6,911,147

Patent Document 6: JP-A-2011-125822

Patent Document 7: WO 2011/122289

### SUMMARY OF THE INVENTION

As shown in FIG. 4, a clarification membrane module is mounted in a filtration device F1 generally in such a state that the closed ends 3, which have a water port 6 therein that serves as an inlet for water to be treated or for air, are located on the lower side and the open ends 2, which have openings through which filtrate passes, are located above the closed ends 3, from the standpoint of the simplicity of air scrubbing.

In the case where the clarification membrane module is thus disposed so that the open ends 2 are located on the upper side, the backwashing water in backwashing flows satisfactorily in the vicinity of the open ends 2 because the filtrate flow channels, through which the backwashing water for the clarification membranes 1 flows, has low flow channel resistance around the open ends 2 located on the upper side. However, in the vicinity of the closed ends 3, the filtrate flow channels, through which the backwashing water for the clarification membranes 1 flows, have high flow channel resistance and, hence, the backwashing water is less apt to flow. As a result, there has been a problem in that the effect of cleaning the clarification membranes 1 is not sufficiently obtained in the vicinity of the closed ends 3. In air scrubbing also, there has been a problem in that since the closed ends 3 of the clarification membranes 1 have been fixed to the case, the vibrations due to the flow of the gas (air) are insufficient and the suspended substance adherent in the vicinity of the closed ends 3 cannot be completely removed.

An object of the present invention is to provide a method for operating a clarification membrane module including clarification membranes, the method enabling the clarification membrane module to show improved cleanability and have an improved throughput capacity.

In order to solve the above-mentioned problem, a method for operating a clarification membrane module according to embodiments of the present invention includes the following features.

(1) A method for operating a clarification membrane module which includes external-pressure type hollow-fiber clarification membranes and in which water to be treated is passed through the clarification membranes from an outer side thereof toward an inner side thereof to obtain filtrate,

the clarification membranes each having a filtrate flow channel and having, at one end thereof, an open end where the filtrate flow channel is open and, at the other end, a closed end where the filtrate flow channel is closed,

the method including: performing a filtration step in which while keeping the clarification membranes so that a position of the open ends is above a position of the closed ends, water to be treated is filtrated from the outer side to the inner side of each clarification membrane and the filtrate obtained is taken out through the open ends; and performing a closed-end high-position cleaning step after making the position of the closed ends above the position of the open ends, the closed-end high-position cleaning step being either the following step (a) or step (b):

(a) closed-end high-position cleaning step A in which the outer side of the clarification membranes within the clarification membrane module is filled with liquid and air scrubbing is then performed by supplying a gas;

(b) closed-end high-position cleaning step B in which air scrubbing is performed by supplying a gas, while supplying liquid to the outer side of the clarification membranes within the clarification membrane module.

(2) A method for operating a clarification membrane module which includes external-pressure type hollow-fiber clarification membranes and in which water to be treated is passed through the clarification membranes from an outer side thereof toward an inner side thereof to obtain filtrate,

the clarification membranes each having a filtrate flow channel and having, at one end thereof, an open end where the filtrate flow channel is open and, at the other end, a closed end where the filtrate flow channel is closed,

in which the clarification membrane module which has undergone at least one repetition of an operation cycle is subjected, after a position of the closed ends is made above a position of the open ends, to a closed-end high-position cleaning step which is either the following step (a) or step (b):

(a) closed-end high-position cleaning step A in which the outer side of the clarification membranes within the clarification membrane module is filled with liquid and air scrubbing is then performed by supplying a gas;

(b) closed-end high-position cleaning step B in which air scrubbing is performed by supplying a gas, while supplying liquid to the outer side of the clarification membranes within the clarification membrane module,

the operation cycle including: a filtration step in which while keeping the clarification membranes so that the position of the open ends is above the position of the closed ends, water to be treated is filtrated from the outer side to the inner side of each clarification membrane and the filtrate obtained is taken out through the open ends; and an open-end high-position backwashing step in which cleaning water is supplied from the open ends to thereby extrude the cleaning water from the inner side to the outer side of the clarification membranes and perform backpressure washing of the clarification membranes.

(3) The method for operating a clarification membrane module according to (1) or (2), in which the liquid is at least one selected from the group consisting of the water to be treated, the filtrate, and clarified water.
(4) The method for operating a clarification membrane module according to (1) or (2), in which, in the closed-end high-position cleaning step B, the liquid is supplied from the open ends to the outer side of the clarification membranes via the inner side of the clarification membranes by backpressure washing, and the liquid to be used for the backpressure washing is either the filtrate or clarified water.
(5) The method for operating a clarification membrane module according to (2), in which air scrubbing in which a gas is supplied from a closed-end side to an inside of the clarification membrane module is performed before or after the open-end high-position backwashing step or simultaneously with the open-end high-position backwashing step.
(6) The method for operating a clarification membrane module according to any one of (1) to (5), in which the clarification membranes are kept in contact with a liquid chemical for a given time period before performing the closed-end high-position cleaning step.
(7) The method for operating a clarification membrane module according to any one of (1) to (6), in which, in the closed-end high-position cleaning step, a still-standing step in which the supply of the liquid and the supply of the gas are stopped to stop movement of water within the clarification membrane module is performed at least once.

According to the method of an embodiment of the present invention for operating a clarification membrane module, the clarification membranes are cleaned while being kept in such a state that the closed ends are located above the open ends. Due to this closed-end high-position cleaning step, the cleaning of a clarification membrane module which has been difficult to efficiently clean so far can be efficiently cleaned. In particular, the suspended substance which is adherent to portions of the clarification membranes that are located near the closed ends is effectively removed.

### BRIEF DESCRIPTION OF THE DRAWINGS

FIG. 1 is a diagrammatic vertical sectional view of one example of clarification membrane modules usable for practicing the present invention.

FIG. 2 is a diagrammatic vertical sectional view of another example of the clarification membrane modules usable for practicing the present invention.

FIG. 3 is a diagrammatic vertical sectional view of still another example of the clarification membrane modules usable for practicing the present invention.

FIG. 4 is a diagrammatic flowchart for illustrating an example of the filtration step in practicing the present invention.

FIG. 5 is a diagrammatic flowchart for illustrating an example of the closed-end high-position cleaning step in practicing the present invention.

### DETAILED DESCRIPTION OF EMBODIMENTS OF THE INVENTION

Embodiments of the present invention are explained below while referring to the drawings. The present invention should not be construed at all as being limited to the following embodiments.

In this description, the terms “upper” and “lower” mean directions for the clarification membrane module in the state of having been disposed for use, and are based on the state shown in each drawing.

Examples of the water to be treated by filtration in practicing the present invention include various kinds of water such as seawater, river water, ground water, and treated sewage or wastewater.

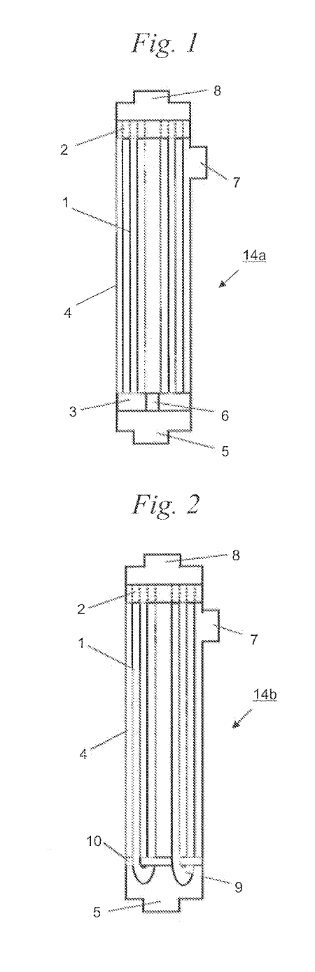

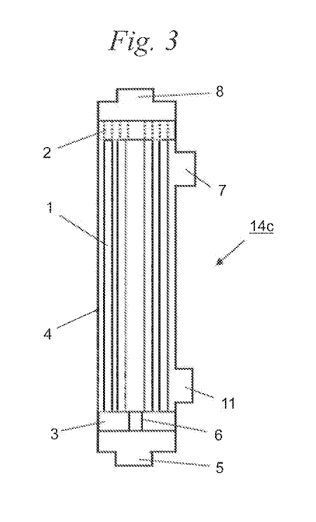

Different embodiments of clarification membrane modules usable in practicing the present invention are explained using FIG. 1, FIG. 2, and FIG. 3, respectively.

The clarification membrane module 14a shown in FIG. 1 is configured of a case (cylindrical case) 4 and external-pressure type clarification membranes 1 which are constituted of bundles of a large number of hollow-fiber membranes and housed in the case 4. The external-pressure type hollow-fiber clarification membranes are clarification membranes with which filtrate can be obtained from water to be treated, by passing the water from the outer side thereof toward the inner side thereof.

In the upper end of the clarification membranes 1, each hollow-fiber membrane has been embedded in a potting material, and the hollows of these membranes in the upper end are open in the upper surface of the potting material. The peripheral side surface of the potting material has been fixed to the inner circumferential surface of the case 4. The clarification membranes 1 in this state have open ends 2 formed by the potting material. Filtrate is taken out through the open ends 2.

In the lower end of the clarification membranes 1, each hollow-fiber membrane has been embedded in a potting material, and the hollows of these membranes in the lower end have been filled with the potting material. Namely, the filtrate flow channels of the clarification membranes 1 are in a closed state. The peripheral side surface of the potting material has been fixed to the inner circumferential surface of the case 4. The clarification membranes 1 in this state have closed ends 3 formed by the potting material. At the center of the potting material which constitutes the closed ends 3, a water port 6 through which water to be treated passes has been disposed.

In the clarification membrane module 14a, the water to be treated which has flowed thereinto through the water port 6 is passed through the clarification membranes 1 from the outer surfaces thereof to the inner surfaces surrounding the hollows and is thereby filtrated, becoming filtrate. The filtrate flows out through the openings of the hollows of the clarification membranes 1 in the open ends 2.

The clarification membrane module 14a includes a water-to-be-treated feed nozzle 5 for supplying water to be treated, a filtrate discharge nozzle 8 for taking out filtrate, and a drain nozzle 7 for discharging excess water within the case 4.

In FIG. 2 is shown a clarification membrane module 14b which has a structure different from that of the clarification membrane module 14a shown in FIG. 1. In FIG. 2, the clarification membrane module 14b has a structure in which clarification membranes 1 have been bent around a liner 10 and folded back into a U-shape and the upper ends only have been potted with a potting material. Due to this potting material, open ends 2 similar to the open ends 2 within the clarification membrane module 14a of FIG. 1 have been formed. The folded part 9 of the clarification membranes 1 may have been fixed with the liner 10. Due to the folded part 9 of the clarification membranes 1 which has been disposed around the liner 10, closed ends having a function similar to that of the closed ends 3 within the clarification membrane module 14a of FIG. 1 have been formed.

The expression “the filtrate flow channels of clarification membranes are in a closed state” means not only the state in which the filtrate flow channels have been closed with a potting material as shown in FIG. 1 but also the state in which the clarification membranes have been folded back to form stagnation portions as shown in FIG. 2.

FIG. 3 shows a clarification membrane module 14c which has another structure different from that of the clarification membrane module 14a shown in FIG. 1. The clarification membrane module 14c shown in FIG. 3 differs from the clarification membrane module 14a shown in FIG. 1, in that a drain nozzle (drain port) 11 has been provided to the case 4 in the vicinity of the closed ends 3 within the clarification membrane module 14a shown in FIG. 1.

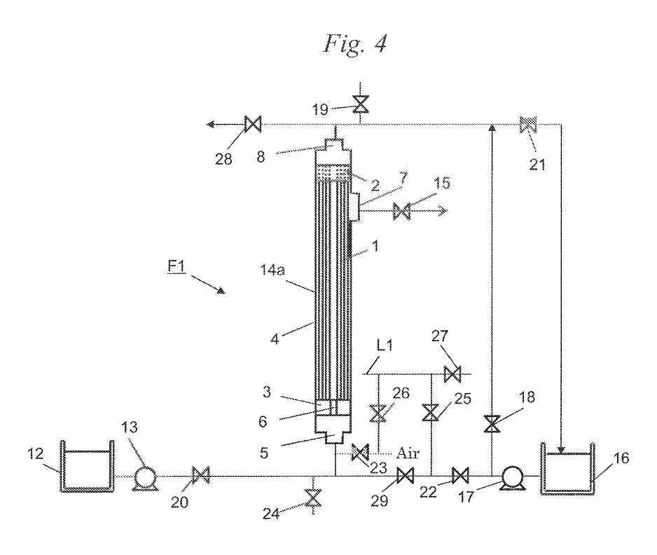

FIG. 4 shows an example of filtration devices usable in practicing the method of the present invention for operating a clarification membrane module.

A filtration step in this filtration device F1 is conducted in the following manner. The water to be treated which has been stored in a water-to-be-treated tank 12 is fed by a water-to-be-treated pump 13 to a clarification membrane module 14a via a water port 6 provided to the closed ends 3, and the water to be treated is filtrated with the clarification membranes 1 of the clarification membrane module 14a. The filtrate obtained is stored in a filtrate tank 16 via the openings formed in the open ends 2.

During this filtration step, a water-to-be-treated valve 20 and a filtrate valve 21 are open, and a first drain valve 15, second drain valve 24, third drain valve 27, fourth drain valve 28, first backwashing valve 18, second backwashing valve 22, first air feed valve 23, second air feed valve 26, first water-to-be-treated/filtrate valve 25, and second water-to-be-treated/filtrate valve 29 are in the closed state. The air vent valve 19 may be either open or closed.

This filtration step includes: a step in which the water to be treated is fed from the water-to-be-treated tank 12 to the clarification membrane module 14a; a step in which the water to be treated is filtrated from the outer side to the inner side of the clarification membranes 1; and a step in which the filtrate is supplied to the filtrate tank 16. The filtration period may be set at any desired length. However, the filtration period for one operation is desirably about 15 minutes to 2 hours, from the standpoint of preventing suspended substance from accumulating excessively in the clarification membrane module 14a. When terminating the filtration step, the water-to-be-treated pump 13 is stopped and the water-to-be-treated valve 20 and the filtrate valve 21 are closed.

Next, the step of cleaning the clarification membranes 1 in the filtration device F1 is performed in the following manner.

First, while keeping the clarification membranes 1 so that the position of the open ends 2 is above the position of the closed ends 3, the first backwashing valve 18 and the first drain valve 15 are opened and the backwashing pump 17 is operated. Thus, the filtrate stored in the filtrate tank 16 is supplied as cleaning water through the filtrate discharge nozzle 8 of the clarification membrane module 14a and is passed from the inner side to the outer side of the clarification membranes 1, thereby performing backwashing of the clarification membranes 1. The suspended substance separated from the clarification membranes 1 is discharged through the first drain valve 15, disposed on the open ends 2 side, together with the backwashing drain. At this stage, the water-to-be-treated valve 20, filtrate valve 21, second backwashing valve 22, second drain valve 24, third drain valve 27, fourth drain valve 28, first air feed valve 23, second air feed valve 26, first water-to-be-treated/filtrate valve 25, and second water-to-be-treated/filtrate valve 29 are in the closed state. The air vent valve 19 may be either open or closed. Although the filtrate obtained by the filtration step may be used as the cleaning water as shown above, use may be made of separately prepared clarified water such as distilled water, RO permeate, or tap water.

This backwashing step is one example of the open-end high-position backwashing step.

Another example of the open-end high-position backwashing step is as follows. The first drain valve 15 and the second drain valve 24 are opened and the backwashing pump 17 is operated. Thus, the water remaining on the outer side of the clarification membranes 1 is discharged from the clarification membrane module in stages or continuously. This method, in which the clarification membrane in which at least some of the outer side thereof is in a gaseous state is subjected to backwashing, is also advantageous.

In cases when backwashing is thus performed while keeping the clarification membranes in such a state that at least some of the outer side thereof is in a gaseous state, the hydraulic resistance on the outer side of the clarification membranes is eliminated and, hence, the suspended substance is more apt to be separated than from the clarification membranes in such a state that the outer surfaces thereof are covered with a liquid. The suspended substance thus separated falls in drops along the surfaces of the clarification membranes and is discharged from the clarification membrane module through the second drain valve 24. It is desirable that at this stage, the level of the water which covers the outer side of the clarification membranes should be kept as low as possible. In cases when the backwashing flow rate is higher than the discharge flow rate of the backwashing drain through the second drain valve 24, the water level does not descend. It is hence effective, for lowering the water level, to introduce compressed air through the drain nozzle 7 to thereby heighten the discharge flow rate of the backwashing drain present on the outer side of the clarification membranes.

After the outer side of the clarification membranes within the clarification membrane module 14a has come into the state of being filled with a gas, the first drain valve 15 is closed and the second drain valve 24 only is opened. As a result, the clarification membrane module 14a has no air discharge port, and the filtrate which has been supplied from the inner side to the outer side of the clarification membranes 1 is wholly discharged as backwashing drain through the water port 6. Thus, no increase in water level occurs, and the backwashing can be efficiently performed while keeping the outer side of the clarification membranes 1 in a gaseous state.

It is preferable that prior to the open-end high-position backwashing step, the first drain valve 15 and the second drain valve 24 should be opened to thereby discharge all of the water to be treated which is present in the clarification membrane module 14a.

At the time when the open-end high-position backwashing step is to be terminated, the first backwashing valve 18 is closed and the backwashing pump 17 is stopped.

After termination of the open-end high-position backwashing step, the procedure to be performed before returning this clarification membrane module 14a to the filtration step is just to open the first drain valve 15 and the second drain valve 24 to discharge the backwashing drain remaining in the clarification membrane module 14a.

Before, after, and/or simultaneously with the open-end high-position backwashing step, air scrubbing may be performed in which the first air feed valve 23 and the first drain valve 15 are opened and air is supplied from the first air feed valve 23 to the clarification membrane module 14a via the water port 6. In this air scrubbing, the ascending air (gas) brings about shear force and severely vibrates the clarification membranes 1, thereby further heightening the effect of removing the suspended substance from the clarification membranes 1.

In the case of performing air scrubbing before the open-end high-position backwashing step, the clarification membrane module 14a which has undergone the filtration step and is in such a state that the outer side of the clarification membranes 1 within the clarification membrane module 14a is filled with the water to be treated may be subjected to air scrubbing.

Meanwhile, in the case of performing air scrubbing after the open-end high-position backwashing step, the following methods may be used. In cases when the open-end high-position backwashing step has been performed while keeping the inside of the clarification membrane module 14a being filled with water, this clarification membrane module 14a filled with the remaining backwashing drain may be subjected to air scrubbing. However, in cases when the water level has declined, air scrubbing may be performed while supplying a liquid (water) to the outer side of the clarification membranes 1 within the clarification membrane module 14a or may be performed after supplying a liquid (water) thereto. The liquid (water) to be supplied in this stage may be either the water to be treated or the filtrate.

In the case of performing air scrubbing simultaneously with the open-end high-position backwashing step, it is desirable that the water level in the outer side of the clarification membranes 1 within the clarification membrane module 14a should be kept as high as possible, preferably at the highest water level, although the second drain valve 24 may be open or closed. This is because a high water level enables the shear force caused by the air scrubbing to be exerted on the whole clarification membranes 1.

In the case where the filtration step, open-end high-position backwashing step, and air scrubbing described above are repeated and the clarification membrane module 14a is operated over a period of several months to several years, there is a tendency that suspended substance gradually accumulates around the open ends 2 and closed ends 3 within the clarification membrane module 14a. In particular, the accumulation of suspended substance around the closed ends 3 is severe.

The reasons for this are as follows. In the open-end high-position backwashing step, the backwashing water flows satisfactorily in the vicinity of the open ends 2 because the filtrate flow channels, through which the backwashing water for the clarification membranes 1 flows, has low flow channel resistance around the open ends 1 In the vicinity of the closed ends 3, however, the filtrate flow channels, through which the backwashing water for the clarification membranes 1 flows, have high flow channel resistance and, hence, the backwashing water is less apt to flow. Another reason is that even when the clarification membrane module 14a in which the outer side of the clarification membranes 1 is in a gaseous state is subjected to backwashing, the backwashing drain is prone to gather around the closed ends 3 and the water pressure due to the gathered backwashing drain inhibits separation of the suspended substance or causes the suspended substance which has separated from upper portions to be trapped between membrane bundles in the vicinity of the closed ends. Still another reason is that even when air scrubbing is performed in combination with the backwashing, not only the vibrations due to the movement of the gas are insufficient but also the flow of the gas in the water port 6, serving as a gas feed port, is prone to be uneven and there is a region through which no gas passes, since the clarification membranes 1 have been fixed with a potting material around the closed ends 3.

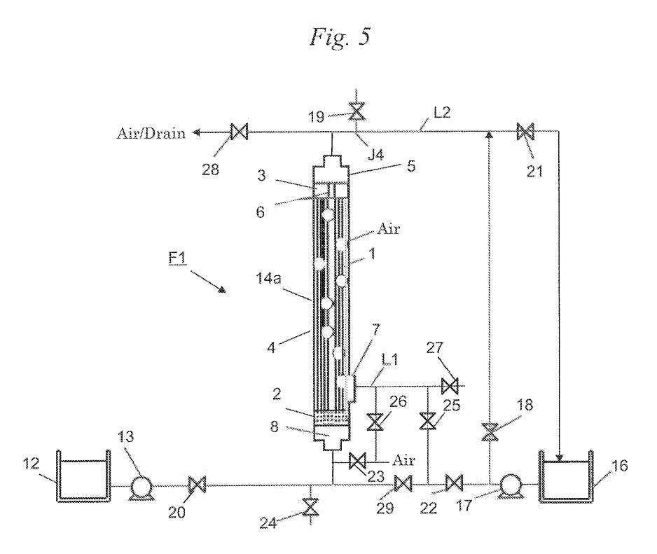

Hence, in order to remove the suspended substance which has accumulated near the closed ends 3, a closed-end high-position cleaning step is performed. Next, the closed-end high-position cleaning is explained using FIG. 5.

First, the longitudinal (vertical) orientation of the clarification membrane module 14a is rotated so that the position of the closed ends 3 of the clarification membranes 1 is above the position of the open ends 2. In FIG. 5, the vertical arrangement of the closed ends 3 and open ends 2 of the clarification membrane module 14a of the filtration device F1 shown in FIG. 4 has been completely reversed so that the closed ends 3 are located on the upper side and the open ends 2 are located on the lower side. The drain nozzle 7 has been connected to a water-to-be-treated/filtrate line L1 for supplying the water to be treated or the filtrate to the clarification membrane module 14a.

In the case of rotating the clarification membrane module, it is preferable from the standpoint of operation efficiency that the water remaining in the outer side of the clarification membranes within the clarification membrane module should be discharged and this clarification membrane module filled with a gas should be rotated.

Thereafter, liquid (water) is supplied to the inside of the clarification membrane module 14a, and the second air feed valve 26 and the fourth drain valve 28 are opened to perform air scrubbing in which air is supplied to the clarification membrane module 14a.

The air scrubbing may be initiated when the outer side of the clarification membranes 1 within the clarification membrane module 14a is in the state of having been filled with liquid (water) beforehand (closed-end high-position cleaning step A), or may be performed while supplying liquid (water) to the outer side of the clarification membranes 1 within the clarification membrane module 14a (closed-end high-position cleaning step B). However, the closed-end high-position cleaning step B is preferred since separation of the suspended substance and removal thereof from the clarification membrane module 14a are simultaneously attained and the cleaning effect is hence enhanced.

Examples of methods for filling the outer side of the clarification membranes 1 with liquid (water) include a method in which liquid is supplied from the outer side of the clarification membranes 1 and a method in which liquid is supplied from the inner side of the clarification membranes 1 by backpressure washing. Examples of the method in which liquid is supplied from the outer side of the clarification membranes 1 include: a method in which the second backwashing valve 22, first water-to-be-treated/filtrate valve 25, and fourth drain valve 28 are opened and the backwashing pump 17 is operated to supply the filtrate via the drain nozzle 7 from the outer side of the clarification membranes 1 within the clarification membrane module 14a; and a method in which the water-to-be-treated valve 20, first water-to-be-treated/filtrate valve 25, second water-to-be-treated/filtrate valve 29, and fourth drain valve 28 are opened and the water-to-be-treated pump 13 is operated to supply the water to be treated, via the drain nozzle 7 from the outer side of the clarification membranes 1 within the clarification membrane module 14a. Meanwhile, examples of the method in which liquid is supplied from the inner side of the clarification membranes 1 by backpressure washing include: a method in which the second backwashing valve 22, second water-to-be-treated/filtrate valve 29, and fourth drain valve 28 are opened and the backwashing pump 17 is operated to supply the filtrate through the filtrate discharge nozzle 8 of the clarification membrane module to the outer side of the clarification membranes 1 by backwashing in which the supplied filtrate is passed through the clarification membranes 1; and a method in which a tank for storing clarified water therein is disposed beforehand side by side with the filtrate tank and the clarified water is supplied through the filtrate discharge nozzle 8 to the outer side of the clarification membranes 1 by backwashing in which the supplied water is passed through the clarification membranes 1, in the same manner as shown above.

In the closed-end high-position cleaning step A, the outer side of the clarification membranes 1 within the clarification membrane module 14a is filled with liquid (water). Thereafter, the second backwashing valve 22, first water-to-be-treated/filtrate valve 25, water-to-be-treated valve 20, and second water-to-be-treated/filtrate valve 29 are closed, and the water-to-be-treated pump 13 or the backwashing pump 17 is stopped to stop the supply of the liquid (water) to the clarification membrane module 14a. Next, the second air feed valve 26 and the fourth drain valve 28 are opened to perform air scrubbing in which air is supplied to the clarification membrane module 14a. The air which has been supplied to the clarification membrane module 14a from the second air feed valve 26 via the drain nozzle 7 ascends in the water present on the outer side of the clarification membranes 1 within the clarification membrane module 14a, passes through the water port 6, and is discharged from the clarification membrane module 14a via the water-to-be-treated feed nozzle 5 and the fourth drain valve 28.

In the closed-end high-position cleaning step B, either the liquid (water) supplied to the outer side of the clarification membranes 1 within the clarification membrane module 14a from the filtrate discharge nozzle 8 via the open ends 2 and via the inner side of the clarification membranes 1 or the liquid (water) supplied to the outer side of the clarification membranes 1 within the clarification membrane module 14a from the drain nozzle 7 forms a gas/liquid mixture fluid together with the air supplied to the outer side of the clarification membranes 1 within the clarification membrane module 14a from the second air feed valve 26 via the drain nozzle 7. This gas/liquid mixture fluid passes through the water port 6 and is discharged from the clarification membrane module 14a through the water-to-be-treated feed nozzle 5 and via the fourth drain valve 28.

In this closed-end high-position cleaning step B, it is preferable that liquid (water) should be supplied by backwashing to the outer side of the clarification membranes 1 within the clarification membrane module 14a from the filtrate discharge nozzle 8 through the open ends 2 and via the inner side of the clarification membranes 1. This is because the suspended substances which have been brought, by the backwashing, into the state of being easily separable from the membranes can be completely separated and removed by the air scrubbing.

The closed-end high-position cleaning step may be interrupted by a still-standing step in which the supply of the liquid and the supply of the gas are stopped and the movement of water within the water to be treated module is stopped. Due to this still-standing step, a flow of water generates in the clarification membrane module in which the water has been still, resulting in an enhanced cleaning effect. Furthermore, in the closed-end high-position cleaning step B, it is preferable that the clarification membrane module in which the outer side of the clarification membranes is in a gaseous state should be repeatedly subjected to the closed-end high-position cleaning and the still-standing step to thereby intermittently elevate the liquid level. This is because the membranes are most severely vibrated and highly effectively cleaned at the gas/liquid interface where the bubbles are released into the air and, hence, the whole membranes can be efficiently cleaned by intermittently elevating the gas/liquid interface.

Thereafter, the third drain valve 27 is opened to discharge the water within the clarification membrane module 14a. Thus, the suspended substance remaining in the clarification membrane module 14a is removed from the clarification membrane module 14a via the third drain valve 27.

In the closed-end high-position cleaning step, the direction of the flow of air is reverse to that in the air scrubbing in which the open ends lay at a high position. Because of this, air is introduced even into the regions where no air flow occurred in the air scrubbing in which the open ends lay at a high position, and the fouling substances which have accumulated around the closed ends can be removed.

It is desirable that in combination with the closed-end high-position cleaning step, backwashing should be conducted while keeping the closed ends at a high position. For example, the backwashing step in which the closed ends are kept at a high position is performed in the following manner. First, the third drain valve 27 and the fourth drain valve 28 are opened to discharge at least some of the water present in the outer side of the clarification membranes within the clarification membrane module, thereby exposing, to the air, a portion of the clarification membranes 1 which is on the closed ends 3 side.

Next, the second backwashing valve 22 and the second water-to-be-treated/filtrate valve 29 are opened, and the backwashing pump 17 is operated to pass the filtrate through the clarification membranes from the inner side to the outer side thereof, thereby performing backwashing. In this backwashing, the backwashing drain which has passed through the clarification membranes to the outer side thereof is discharged from the clarification membrane module through the third drain valve 27. In the vicinity of the closed ends 3, since the outer side of the clarification membranes 1 are in the state of being exposed to the air and hence have no hydraulic resistance, the filtrate selectively passes through. Consequently, the effect of highly cleaning that portion of the clarification membranes 1 is obtained.

In the embodiments explained above, the closed-end high-position cleaning step was performed using the same device as the filtration device. However, the clarification membrane module may be demounted from the filtration device and mounted on a device for cleaning only to perform the closed-end high-position cleaning step.

In the present invention, it is preferable that the liquid (water) to be supplied to the outer side of the clarification membranes within the clarification membrane module in the closed-end high-position cleaning step should be properly selected by changing the way of supplying the liquid. Specifically, in the case of filling the outer side of the clarification membranes with liquid by directly introducing the liquid thereinto without via the inner side of the clarification membranes, use can be made, as the liquid, of the water to be treated, the filtrate, or clarified water prepared separately, such as distilled water, RO permeate and tap water. Meanwhile, in the case where liquid is introduced into the outer side of the clarification membranes via the inner side of the clarification membranes to fill the outer side, it is preferred to use the filtrate or separately prepared clarified water such as distilled water, RO permeate and tap water, as the liquid. By properly using liquid in such a manner, the inner side of the clarification membranes can be prevented from being fouled.

When the filtration step is terminated and the closed-end high-position cleaning step is to be performed, it is desirable that a liquid chemical is added to the liquid (water) for filling the outer side of the clarification membranes and the clarification membranes are kept in contact with this liquid for a given time period (chemical cleaning) before performing the closed-end high-position cleaning step. By adding a liquid chemical to the liquid, the suspended substance adherent to the outer side of the clarification membranes is rendered easily separable from the membranes. This suspended substance can be exceedingly effectively removed from the clarification membrane module 14a by performing the closed-end high-position cleaning.

In the case where the filtration step and the open-end high-position backwashing have been repeated at least once, the following steps may be performed after the final filtration step in the following order, in which the chemical cleaning step and the open-end high-position backwashing may be performed in either order. Namely, the chemical cleaning, the open-end high-position backwashing, and the closed-end high-position backwashing may be performed in this order, or the open-end high-position backwashing, the chemical cleaning, and the closed-end high-position backwashing may be performed in this order.

As the liquid chemical, use can be made of an aqueous solution containing a chemical such as hydrochloric acid, sulfuric acid, nitric acid, citric acid, oxalic acid, ascorbic acid, sodium hydrogen sulfite, sodium hydroxide, and sodium hypochlorite. In particular, oxidizing agents such as sodium hypochlorite are effective in removing suspended substance including organic substances from seawater, river water, water obtained by treating sewage/wastewater, etc. The concentration of sodium hypochlorite is preferably 10 to 10,000 mg/L. This is because concentrations thereof lower than 10 mg/L result in an insufficient cleaning effect, while concentrations thereof higher than 10,000 mg/L are uneconomical due to the increased chemical cost. More preferably, the concentration thereof is 100 to 5,000 mg/L.

The cleaning effect is enhanced by keeping the clarification membranes in contact with the liquid for a given time period after the addition of the liquid chemical. The period for which the clarification membranes are kept in contact with the liquid chemical is preferably about 5 minutes to about 3 hours. This is because too short contact periods result in insufficient detergency, while too long a contact period is disadvantageous from the standpoint of profitability because the apparatus needs to be stopped over a prolonged period and hence has a reduced operation efficiency.

The explanation given above was on the case where the filtration step and the open-end high-position backwashing step are repeated to operate the clarification membrane module over a period of several months to several years and the closed-end high-position cleaning step is performed thereafter. However, it is also effective to operate the clarification membrane module while preventing suspended substance from accumulating around the closed ends, by periodically performing the closed-end high-position cleaning step after the filtration step and the open-end high-position backwashing step are conducted several times to tens of times.

With respect to the mode of membrane filtration, the clarification membrane module may be either a dead-end filtration type module or a cross-flow filtration type module.

However, the dead-end filtration type module is preferred from the standpoint that this type is low in energy consumption. Furthermore, the clarification membrane module may be either a pressurized type module or a submerged type module, but the pressurized type module is preferred because this type is capable of high-flux operation.

With respect to the mode of filtration in the hollow-fiber membrane module, the external-pressure type is used in which the water to be treated is filtrated through the hollow-fiber membranes from the outer side to the inner side thereof.

The present invention can effectively remove fouling substances which have accumulated around the closed ends, and is hence especially effective for clarification membrane modules having a membrane area of 5 m² or larger, in which fouling substances are prone to accumulate around the closed ends.

The clarification membranes have an effective length of preferably 0.5 m or larger, more preferably 1.0 m or larger. In the case where the clarification membranes have a small length, the phenomenon in which the closed ends are fouled more is less apt to occur since the filtrate flow channels inside the clarification membranes have low flow channel resistance, and the effects of the present invention are difficult to obtain. The term “effective length” means the length obtained by subtracting the length of the portion embedded in the potting material from the overall length of the clarification membranes, that is, the length of the portion which comes into contact with the water to be treated.

To heighten the degree of membrane packing of the clarification membrane module as much as possible while ensuring water-to-be-treated flow channels is effective since the membrane area can be increased. According to the present invention, since the ends of clarification membrane modules can be efficiently cleaned, the method of an embodiment of the present invention is a cleaning technique which is more effective for clarification membrane modules having a high degree of membrane packing. The degree of membrane packing is preferably 40% or higher. The term “degree of membrane packing” used herein for a pressurized type module means the proportion of the volumes of the clarification membranes and clarification-membrane filtrate flow channels to the volume of the part of the inside of the clarification membrane module case which lies between the closed ends and the open ends. In the case of a submerged type module, that term means the proportion of the area of both the clarification membranes and the filtrate flow channels to the overall horizontal cross-sectional area of the opening part of the clarification membranes in the membrane module held in such a state that the upside/downside direction thereof is vertical, since this module includes no case.

The position of the drain nozzle 7 is not particularly limited. It is, however, preferable that the drain nozzle 7 should have been disposed near the open ends 2 of the clarification membranes 1, because this position brings about a high water discharge efficiency.

It is preferable that the clarification membranes 1 should be microfiltration membranes capable of rejecting particles or polymers having a size of 0.1 μm or larger or ultrafiltration membranes capable of rejecting particles or polymers having a size of 2 nm or larger but less than 0.1 μm.

Examples of the material of the microfiltration membranes and/or ultrafiltration membranes to be used as the clarification filtration membranes include polysulfones, polyethersulfones, polyacrylonitrile, polyimides, polyetherimides, polyamides, polyetherketones, polyetheretherketones, polyethylene, polypropylene, ethylene/vinyl alcohol copolymers, cellulose, cellulose acetate, poly(vinylidene fluoride), ethylene/tetrafluoroethylene copolymers, polytetrafluoroethylene, and composite materials thereof.

Of these, poly(vinylidene fluoride) is preferred for use because poly(vinylidene fluoride) has excellent chemical resistance and, hence, periodic cleaning of the microfiltration membranes and/or ultrafiltration membranes with a chemical enables the microfiltration membranes and/or ultrafiltration membranes to recover the filtration function, leading to a prolongation of the life of the clarification membrane module.

As the material of the case 4 of the clarification membrane module, the following may, for example, be used either alone or as a mixture: polyolefins such as polyethylene, polypropylene, and polybutene, fluororesins such as polytetrafluoroethylene (PTFE), tetrafluoroethylene/perfluoroalkyl vinyl ether copolymers (PFA), fluoroethylene/polypropylene copolymers (FEP), ethylene/tetrafluoroethylene copolymers (ETFE), poly(chlorotrifluoroethylene) (PCTFE), trifluorochloroethylene/ethylene copolymers (ECTFE), and poly(vinylidene fluoride) (PVDF), chlororesins such as poly(vinyl chloride) and poly(vinylidene chloride), and other resins including polysulfone resins, polyethersulfone resins, polyallylsulfone resins, poly(phenyl ether) resins, acrylonitrile/butadiene/styrene copolymer resins (ABS), acrylonitrile/styrene copolymer resins, poly(phenylene sulfide) resins, polyamide resins, polycarbonate resins, polyetherketone resins, and polyetheretherketone resins. Preferred materials other than resins are aluminum, stainless steel, and the like. Furthermore, a composite material such as a resin/metal composite, a glass-fiber-reinforced resin, or a carbon-fiber-reinforced resin may be used.

While the invention has been described in detail and with reference to specific embodiments thereof, it will be apparent to one skilled in the art that various changes and modifications can be made therein without departing from the spirit and scope thereof. This application is based on a Japanese patent application filed on Apr. 25, 2014 (Application No. 2014-091197), the contents thereof being incorporated herein by reference.

### DESCRIPTION OF REFERENCE NUMERALS AND SIGNS

1: Clarification membrane
2: Open end
3: Closed end
4: Case (cylindrical case)
5: Water-to-be-treated feed nozzle
6: Water port
7: Drain nozzle
8: Filtrate discharge nozzle
9: Folded part of clarification membranes
10: Liner
11: Drain nozzle
12: Water-to-be-treated tank
13: Water-to-be-treated pump
14a, 14b, 14c: Clarification membrane module
15: First drain valve
16: Filtrate tank
17: Backwashing pump
18: First backwashing valve
19: Air vent valve
20: Water-to-be-treated valve
21: Filtrate valve
22: Second backwashing valve
23: First air feed valve
24: Second drain valve
25: First water-to-be-treated/filtrate valve
26: Second air feed valve
27: Third drain valve
28: Fourth drain valve
29: Second water-to-be-treated/filtrate valve
F1: Filtration device
L1: Water-to-be-treated/filtrate line

1. A method for operating a clarification membrane module which comprises external-pressure type hollow-fiber clarification membranes and in which water to be treated is passed through the clarification membranes from an outer side thereof toward an inner side thereof to obtain filtrate,
the clarification membranes each having a filtrate flow channel and having, at one end thereof, an open end where the filtrate flow channel is open and, at the other end, a closed end where the filtrate flow channel is closed,
the method comprising: performing a filtration step in which while keeping the clarification membranes so that a position of the open ends is above a position of the closed ends, water to be treated is filtrated from the other side to the inner side of each clarification membrane and the filtrate obtained is taken out through the open ends; and performing closed-end high-position cleaning step after making the position of the closed ends the position of the open ends, the closed-end high-position cleaning step being either the following step (a) or step (b):
(a) closed-end high-position cleaning step A in which the outer side of the clarification membranes within the clarification membrane module is filled with liquid and air scrubbing is then performed by supplying a gas;
(b) closed-end high-position cleaning step B in which air scrubbing is performed by supplying a gas, while supplying liquid to the outer side of the clarification membranes within the clarification membrane module.

2. A method for operating a clarification membrane module which comprises external-pressure type hollow-fiber clarification membranes and in which water to be treated is passed through the clarification membranes from an outer side thereof toward an inner side thereof to obtain filtrate,
the clarification membranes each having a filtrate flow channel and having, at one end thereof, an open end where the filtrate flow channel is open and, at the other end, a closed end where the filtrate flow channel is closed,
wherein the clarification membrane module which has undergone at least one repetition of an operation cycle is subjected, after a position of the closed ends is made above a position of the open ends, to a closed-end high-position cleaning step which is either the following step (a) or step (b):
(a) closed-end high-position cleaning step A in which the outer side of the clarification membranes within the clarification membrane module is filled with liquid and air scrubbing is then performed by supplying a gas;
(b) closed-end high-position cleaning step B in which air scrubbing is performed by supplying a gas, while supplying liquid to the outer side of the clarification membranes within the clarification membrane module,
the operation cycle comprising: a filtration step in which while keeping the clarification membranes so that the position of the open ends is above the position of the closed ends, water to be treated is filtrated from the outer side to the inner side of each clarification membrane and the filtrate obtained is taken out through the open ends; and an open-end high-position backwashing step in which cleaning water is supplied from the open ends to thereby extrude the cleaning water from the inner side to the outer side of the clarification membranes and perform backpressure washing of the clarification membranes.

3. The method for operating a clarification membrane module according to claim 1, wherein the liquid is at least one selected from the group consisting of the water to be treated, the filtrate, and clarified water.

4. The method for operating a clarification membrane module according to claim 1, wherein, in the closed-end high-position cleaning step B, the liquid is supplied from the open ends to the outer side of the clarification membranes via the inner side of the clarification membranes by backpressure washing, and the liquid to be used for the backpressure washing is either the filtrate or clarified water.

5. The method for operating a clarification membrane module according to claim 2, wherein air scrubbing in which a gas is supplied from a closed-end side to an inside of the clarification membrane module is performed before or after the open-end high-position backwashing step or simultaneously with the open-end high-position backwashing step.

6. The method for operating a clarification membrane module according to claim 1, wherein the clarification membranes are kept in contact with a liquid chemical for a given time period before performing the closed-end high-position cleaning step.

7. The method for operating a clarification membrane module according to claim 1, wherein, in the closed-end high-position cleaning step, a still-standing step in which the supply of the liquid and the supply of the gas are stopped to stop movement of water within the clarification membrane module is performed at least once.

8. The method for operating a clarification membrane module according to claim 2, wherein the liquid is at least one selected from the group consisting of the water to be treated, the filtrate, and clarified water.

9. The method for operating a clarification membrane module according to claim 2, wherein, in the closed-end high-position cleaning step B, the liquid is supplied from the open ends to the outer side of the clarification membranes via the inner side of the clarification membranes by backpressure washing, and the liquid to be used for the backpressure washing is either the filtrate or clarified water.

10. The method for operating a clarification membrane module according to claim 2, wherein the clarification membranes are kept in contact with a liquid chemical for a given time period before performing the closed-end high-position cleaning step.

11. The method for operating a clarification membrane module according to claim 2, wherein, in the closed-end high-position cleaning step, a still-standing step in which the supply of the liquid and the supply of the gas are stopped to stop movement of water within the clarification membrane module is performed at least once.
